(19) United States
(12) Patent Application Publication
(10) Pub. No.: US 2012/0120392 A1
(43) Pub. Date: May 17, 2012

(54) Non-traditional agent/dusty agent detection system

(76) Inventors: Kenneth James Ewing, Crofton, MD (US); John Paul Santori, Ellicott City, MD (US); Fred Fu Whiton, JR., Towson, MD (US); Paul George Kahl, JR., Perry Hall, MD (US)

(21) Appl. No.: 11/785,453

(22) Filed: Apr. 18, 2007

(51) Int. Cl. G01J 3/44; G01J 5/02; G01J 3/30

(52) U.S. Cl. 356/301; 356/311; 250/338.1; 250/341.6

(57) ABSTRACT

A chemical agent detection system is described. The system comprises a sample introduction module, an agent concentration module and a detection module. The sample introduction module comprises a sample collector that collects particles and aerosols from a sample, and a heater that vaporizes the collected particles and aerosols and produces a sample vapor. The agent concentration module comprises a sorbent tube filled with a sorbent material that preferentially absorbs the vapor of a target chemical agent when the sample vapor passes through the sorbent tube. The detection module interrogates the sorbent material and identifies the target chemical agent absorbed to the sorbent material. Also disclosed are methods for detecting a non-traditional agent (NTA) or a dusty agent (DA), and trace levels of chemical warfare agents (CWA) and toxic industrial chemical (TIC) vapors.

### FIELD OF THE INVENTION

The present invention generally relates to chemical agent detection systems and, in particular, to detection systems for non-traditional agents, dusty agents, and trace levels of chemical warfare agents and toxic industrial chemical vapors.

### BACKGROUND

Biological and chemical element detection are currently considered to be among the highest priorities to national security. For detection of chemical agents, the general method is to analyze chemical agents in the form of a vapor sample using analytical methods such as Ion Mobility Spectrometry (IMS) and gas chromatography/mass spectrometry (GC/MS).

Non-traditional agents (NTAs) and dusty agents (DAs) are chemical warfare agents (CWA) dispersed as either a liquid or particulate aerosol. The NTAs and DAs typically do not exhibit vapor concentrations high enough for current detectors to detect. For example, IMS technology is used for vapor detection of conventional chemical warfare agents. However, IMS, as well as all other detection technologies requiring vapor samples are not capable of detecting NTAs and DAs because they do not exhibit a significant vapor concentration for IMS detection.

Preconcentration technologies, such as sorbent tube based systems, are used to increase the concentration of an analyte introduced to an analytical device. They operate by collecting relatively large volumes of air, concentrating analytes from that air, then delivering the collected analytes to the detector in a much smaller volume of carrier gas. This causes the concentration of analyte introduced to the detector to be 1 to 4 orders of magnitude larger than originally collected from the air. It is important to note that most analytical devices require a vapor sample and therefore, samples collected using sorbent tube technologies are always thermally desorbed as vapors into most analytical devices.

Raman spectroscopy is a powerful technique capable of identifying many different compounds by analysis of the vibrational properties of the target molecules. Raman spectroscopy is capable of identifying bulk materials such as powders and liquids at the weight percent concentration range, but while Raman spectroscopy might be capable of detecting NTAs and DAs in large quantities, in its current state it is not capable of detecting operational (trace) levels of NTA or DA.

Therefore, there still exists a need for a novel detection technology that is capable of detecting NTAs and DAs with high selectivity and sensitivity.

### SUMMARY OF THE INVENTION

One aspect of the present invention relates to a chemical agent detection system. The system comprises a sample introduction module, an agent concentration module and a detection module. The sample introduction module comprises a sample collector that collects particles and aerosols from a sample, and a heater that vaporizes the collected particles and aerosols and produces a sample vapor. The agent concentration module comprises a sorbent tube filled with a sorbent material that preferentially absorbs the vapor of a target chemical agent when the sample vapor passes through the sorbent tube. The detection module interrogates the sorbent material and identifies the target chemical agent absorbed to the sorbent material.

In one embodiment, the detection module comprises a Raman spectrometer or an infrared spectrometer.

In another embodiment, the sample collector is an electrostatic collector.

In another embodiment, the sorbent material is 2,6-diphenylene oxide.

In yet another embodiment, the chemical agent detection system further comprises a microcontroller, a flash memory, and an external port.

Another aspect of the present invention relates to a method for detecting a non-traditional agent (NTA) or a dusty agent (DA). The method comprises the steps of collecting a sample that may contain a NTA or DA with a particle/aerosol collector; heating the collected sample to produce vapors; passing the vapors through a sorbent material that preferentially absorbs vapors of target chemical agents; and identifying the chemical agent absorbed in the sorbent material using a detection device.

In one embodiment, the method further comprises the step of purging the sorbent material after the identification step.

In another embodiment, the method further comprises the step of performing periodic back ground noise checks to characterize the dynamic range and sensitivity of the detection device.

Yet another aspect of the present invention relates to a method for detecting trace levels of target chemical agents. The method comprises the steps of collecting a sample with a particle/aerosol collector; passing the sample through a sorbent material that preferentially absorbs vapors of said target chemical agents; and identifying the absorbed target chemical agent in the sorbent material with a detection device.

In on embodiment, the target chemical agents comprise chemical warfare agents (CWA) and toxic industrial chemical (TIC) vapors.

### BRIEF DESCRIPTION OF DRAWINGS

FIG. 1 is a diagram showing an embodiment of the chemical agent detection device of the present invention.

FIG. 2 is a flow diagram showing a chemical agent detection method of the present invention.

FIG. 3 is a flow diagram showing another chemical agent detection method of the present invention.

FIG. 4 is a flow diagram showing another chemical agent detection method of the present invention.

### DETAILED DESCRIPTION OF THE INVENTION

In describing preferred embodiments of the present invention, specific terminology is employed for the sake of clarity. However, the invention is not intended to be limited to the specific terminology so selected. It is to be understood that each specific element includes all technical equivalents which operate in a similar manner to accomplish a similar purpose.

One aspect of the present invention relates to a detection system for chemical agents such as non-traditional agents (NTAs), dusty agents (DAs), and trace levels of chemical warfare agent (CWA) or toxic industrial chemical (TIC) vapors. As used hereinafter, the terms “chemical agent,” “CWA,” “NTA,” “DA,” and “TIC” include the agents or chemicals themselves, as well as the decomposed substances or residues of the agents or chemicals that can be used to identify the agents or chemicals.

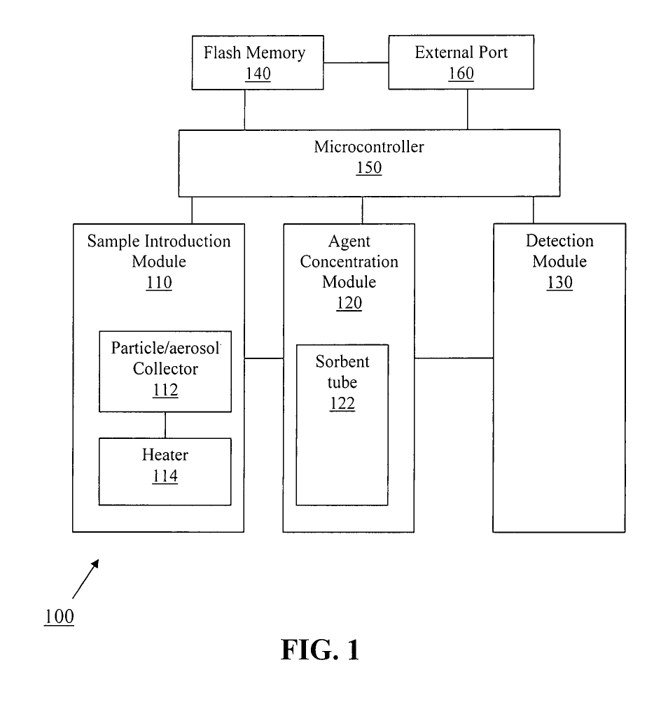

As shown in FIG. 1, the detection system 100 contains a sample introduction module 110, an agent concentration module 120 for concentrating target chemical agents prior to detection, and a detection module 130 for the identification and/or quantification of the collected chemical agents. The detection system can be used to detect non-traditional agents (NTAs), dusty agents (DAs), and trace levels of chemical warfare agent (CWA) or toxic industrial chemical (TIC) vapors.

NTAs and DAs are CWAs dispersed as either a liquid or particulate aerosol. For example, dusty mustard is composed of mustard agent (liquid) dispersed onto fine particulates of silica. Examples of CWA includes, but are not limited to, nerve agents such as GA (Tabun, ethyl N,N-dimethyl phosphoramidocyanidate), GB (Sarin, isopropylmethylphosphorofluoridate), GD (Soman, Trimethylpropylmethylphosphorofluoridate), GF (cyclohexyl-methylphosphorofluoridate) and VX (o-ethyl S-[2-(diiospropylamino)ethyl]methylphosphorofluoridate); vesicants such as HD (mustard, bis-2-chlorethyl sulfide), CX (Phosgene oxime, dichloroformoxime), and L (Lewisite, J-chlorovinyldichloroarsine); cyanides such as AC (Hydrocyanic acid) and CK (Cyanogen chloride); pulmonary agents such as CG (phosgene, carbonyl chloride) and DP (Diphosgene, trichloromethylchlorformate),.

Examples of TIC can be found on U.S. Environmental Protection Agency's reference list of toxic compounds (Alphabetical Order List of Extremely Hazardous Substances” Section 302 of EPCRA).

The sample introduction module 110 comprises a particle/aerosol collector 112 and a heater 114. The particle/aerosol collector 112 can be a commercial off-the-shelf particle/aerosol collector or a collector specifically designed for the detection device 100. Examples of the particle/aerosol collector 112 include, but are not limited to, electrostatic collectors, virtual impactors, regular plate impactors, and filter-based collectors.

In one embodiment, the particle/aerosol collector 112 is an electrostatic collector. The electrostatic collector removes particles from an air sample by using electrostatics to direct the particles or aerosols onto a metal grid or into a liquid, creating a highly concentrated particle/aerosol sample.

In another embodiment, the particle/aerosol collector 112 is a virtual impactor with a desired threshold size. Briefly, a jet of particle-laden air is accelerated toward a collection probe positioned downstream so that a small gap exists between the acceleration nozzle and the probe. A vacuum is applied to deflect a major portion of the airstream through the small gap. Particles larger than a preset threshold size, known as the cutpoint, have sufficient momentum so that they cross the deflected streamlines and enter the collection probe, whereas smaller particles follow the deflected airstream. Larger particles are removed from the collection probe by the minor portion of the airstream according to the magnitude of the vacuum applied to the minor portion.

In another embodiment, the particle/aerosol collector 112 is a regular impactor. The particles are accelerated through a nozzle towards an impactor plate maintained at a fixed distance from the nozzle. The plate deflects the flow creating fluid streamlines around itself. Due to inertia, the larger particles are impacted (and collected) on a collector plate while the smaller particles follow the deflected streamlines.

In another embodiment, the particle/aerosol collector 112 is a filter-based collector that collects the NTA particles or aerosols and DAs on a filter. The filter can be a porous material that traps NTAs and DAs.

The sample can be an air sample collected from atmosphere or from a container. The sample may also be a liquid sample. The collection conditions, such as the sample flow rate and collecting temperature, may be optimized for the chemical agent of interest. The collected particles are then heated by the heater 114 to generate vapors for analysis.

The heater 114 is a device capable of heating the particles or aerosols collected by the particle/aerosol collector 112 to a desired temperature to produce vapors of the target agents (i.e., the CWAs in NTAs or DAs). In the case of the electrostatic collector, the heater 114 heats the solid radial collector (the metal rod which collects aerosols) to the vaporization temperature of the NTA aerosols. For most NTAs, the vaporization temperature is in the range of 100° C. to 300° C. The vaporization temperature may be optimized for the chemical agent of interest to maximize absorption by the concentration module 120.

A common problem for surface collection systems, such as electrostatic collectors and virtual impactors, is that the collected target aerosols or particles are often covered by environmental debris (e.g., dust and other environmental aerosols). The environmental debris may interfere with the interrogation of an optical detection system, for example by blocking the irradiating laser beam from reaching the target aerosols, and significantly reduce the sensitivity of the detection system. This phenomenon, often called shadowing, limits the practicality of a surface collection system by requiring a very short collection interval to minimize shadowing.

The present invention overcomes the shadowing problems by volatilizing any captured NTAs/DAs/CWAs and utilizing the concentration module 120 to concentrate target agent vapors before detection and identification. In one embodiment, the agent concentration module 120 comprises a sorbent tube 122 filled with a sorbent material. The sorbent tube 122 can be of any shape and size. The sorbent material is a material that preferentially collects the target vapors and rejects many background chemical vapors. The sorbent material can be a commercial off-the shelf pre-concentration media commonly used to pre-concentrate chemical vapors prior to analysis. Examples of the sorbent material include, but are not limited to, porous polymer resins such as Tenax (2,6-diphenylene oxide), PIB (poly(isobutylene)), SXPH (75% phenyl-25% methylpolysiloxane), PEM (polyethylene maleate), SXCN (poly bis(cyanopropyl) siloxane), PVTD (poly (vinyltetradecanal)), PECH (poly(epichlorohydrin)), PVPR (poly(vinyl propionate)), OV202 (poly(trifluoropropyl) methyl siloxane), P4V (poly(4-vinylhexafluorocumyl alcohol)), SXFA (1-(4-hydroxy, 4-trifluoromethyl,5,5,5-trifluoro)pentene methylpolysiloxane), FPOL (fluoropolyol), PEI (poly(ethyleneimine), SXPYR (alkylaminopyridyl-substituted siloxane), and polysilsesquioxane.

The NTA/DA/CWA vapors produced in the sample introduction module 110 are drawn into the agent concentration module 120, passing into the sorbent tube 122 and captured on the sorbent material. This step concentrates the NTA/DA/CWA chemical vapors and rejects many possible environmental interferences that could make up the aerosol and chemical vapor background. Once the target vapor is concentrated on the sorbent material, it is interrogated and identified by the detection module 130.

After interrogation by the detection module 130, the sorbent tube 122 is heated and purged with air or an inert gas to remove the absorbed agent in the sorbent material. Preferably, the detection system 100 is designed in such a way so that the sorbent tube 122 can be easily replaced when its useful life is spent. In one embodiment, the sorbent tube 122 is covered by an access door with minimal fasteners.

The detection module 130 may use any techniques capable of detecting the concentrated target vapor on the sorbent material. In one embodiment, the detection method is a spectroscopic interrogation technique. Examples of the spectroscopic interrogation techniques include, but are not limited to, Raman spectroscopy, infrared spectroscopy (IRS), mass spectrometry (MS), gas chromatography (GC), Fourier transform infrared spectrometry (FTIRS), ion mobility spectrometry (IMS), photoacoustic infrared spectroscopy (PAIRS), and in-flame photometry (IFP).

In one embodiment, the detection method is Raman spectroscopy. Raman spectroscopy is based upon the interaction between optical radiation and various chemical species present in a sample. When the sample is irradiated with optical radiation a fraction of the optical radiation is scattered by the molecules in the sample. The scattered radiation differs from the wavelength of the initial radiation by an amount proportional to the vibrational modes within the target molecules. The difference between the scattered radiation and incident beam, termed the Raman shift, corresponds to molecular vibrations in the target molecule. The degree of Raman shift is dependent upon the chemical structure of the molecules causing the scattering. During irradiation, the spectrum of the scattered radiation is measured with a spectrometer. In a preferred embodiment, the detection method is fiber optic Raman spectroscopy. In another embodiment, the spectroscopic interrogation unit 130 is an Ahura hand held Raman FirstDefender system (Ahura Corporation, Wilmington, Mass.).

In another embodiment, the detection method is IRS. Characteristic vibrational wavelengths of most CW agents occur in the infrared (IR) region of the electromagnetic spectrum. When infrared radiation passes through a gas or vapor, or is reflected off a surface (diffuse reflection), adsorption of radiation occurs at specific wavelengths that are characteristic of the vibrational structure of the gas molecules. Routine IR instruments measure the amount of light absorbed at a specific wavelength to look for a characteristic chemical group, such as the phosphorus-oxygen bond of nerve agents. More sophisticated instruments scan regions of the IR spectrum to generate a “fingerprint” pattern for individual chemicals.

In another embodiment, the detection method is MS. A sample is introduced into a mass spectrometer, a charge is imparted to the molecules present in the sample, and the resultant ions are separated by the mass analyzer component of the mass spectrometer. MS instruments measure the mass to charge ratio of the ions. A mass spectrum appears as a number of peaks on a graph. This technique only requires a few nanomoles of sample to obtain characteristic information regarding the structure and molecular weight of the analyte. Mass spectrometers can be specifically designed to detect various chemical agents and have enormous applicability in detecting agents in most types of samples.

In another embodiment, the detection method is GC. GC detectors can be used to detect a variety of chemical agents. Vaporized sample is swept onto a chromatographic column by the inert carrier gas and serves as the mobile phase. After passing through the column the solutes of interest generate a signal for a recording device to read. Like mass spectroscopy, this method also offers high sensitivity and specificity in detecting chemical agent in many sample forms.

Samples separated by GC may be further analyzed by MS in a GC/MS detection system. GC may also be coupled with FTIRS. FTIRS is a technique that can identify compounds that are separated by gas chromatography. After the separation of the compounds, the sample passes through a light pipe where an infrared (IR) beam is passed through it. The adsorption of the IR energy is monitored as the signal is continuously scanned. Scans are collected on each peak and the signals are then manipulated with a Fourier transform that enhances the signal to noise ratio of the spectra taken.

In another embodiment, the detection method is IMS. IMS operates by drawing air at atmospheric pressure into a reaction region where the constituents of the sample are ionized. The ionization is generally a collisional charge exchange or ion-molecule reaction, resulting in formation of low-energy, stable, charged molecules (ions). The agent ions travel through a charged tube where they collide with a detector plate and a charge (current) is registered. A plot of the current generated over time provides a characteristic ion mobility spectrum with a series of peaks. The intensity (height) of the peaks in the spectrum, which corresponds to the amount of charge, gives an indication of the relative concentration of the agent present.

In another embodiment, the detection method is PAIRS. As in IRS, PAIRS uses selective adsorption of infrared radiation by the target agent vapors to identify and quantify the agent present. A specific wavelength of infrared light is pulsated into a sample through an optical filter. The light transmitted by the optical filter is selectively adsorbed by the gas being monitored, which increases the temperature of the gas as well as the pressure of the gas. Because the light entering the cell is pulsating, the pressure in the cell will also fluctuate, creating an acoustic wave in the cell that is directly proportional to the concentration of the gas in the cell. Two microphones mounted inside the cell monitor the acoustic signal produced and send results to the control station.

In another embodiment, the detection method is IFP. An air sample is burned in a hydrogen-rich flame. The compounds present emit light of specific wavelengths in the flame. An optical filter is used to let a specific wavelength of light pass through it. A photo-sensitive detector produces a representative response signal. Since most elements will emit a unique and characteristic wavelength of light when burned in this flame, this device allows for the detection of specific elements.

In another embodiment, the detection module 130 comprises photo ionization detectors (PIDs). PID operates by passing the air sample between two charged metal electrodes in a vacuum that are irradiated with ultraviolet radiation, thus producing ions and electrons. The negatively charged electrode collects the positive ions, thus generating a current that is measured using an electrometer-type electronic circuit. The measured current can then be related to the concentration of the molecular species present.

In another embodiment, the detection module 130 comprises surface acoustic wave (SAW) sensors. SAW sensors detect changes in the properties of acoustic waves as they travel at ultrasonic frequencies in piezoelectric materials. The basic transduction mechanism involves interaction of these waves with surface-attached matter. Multiple sensor arrays with multiple coatings and pattern recognition algorithms provide the means to identify agent classes and reject interferant responses that could cause false alarms.

In another embodiment, the detection module 130 comprises electrochemical sensors. Electrochemical sensors function by quantifying the interaction between an analyte's molecular chemistry and the properties of an electrical circuit. Fundamentally, electrochemistry is based on a chemical reaction that occurs when the target agent enters the detection region and produces some change in the electrical potential. This change is normally monitored through an electrode. A threshold concentration of agent is required, which corresponds to a change in the monitored electrical potential. This sensor technology provides a wide variety of possible configurations.

In yet another embodiment, the detection module 130 comprises thermoelectric conductivity sensors. The electrical conductivity of certain materials can be strongly modulated following surface adsorption of various chemicals. Heated metal oxide semiconductors and room-temperature conductive polymers are two such materials that have been used commercially. The change in sensor conductivity can be measured using a simple electronic circuit, and the quantification of this resistance change forms the basis of sensor technology.

The detection system 100 may further comprise a flash memory 140, a microcontroller 150, and an external port 160. The flash memory 140 may be used to store libraries of spectrometry finger prints of chemical agents and operation software. The microcontroller 150 monitors and controls the operation of the detection system 100. For example, the microcontroller 150 may stage the timing and temperature of the sample introduction module 110 and the agent concentration module 120, and compare the results from the detection module 130 with the libraries of spectrometry finger print of chemical agents in the flash memory 140 to identify the target agent and reduce false positives. The microcontroller 150 is preferably small, lightweight and available as a standard commercial off-the-shelf (COTS) product. In one embodiment, the microcontroller 150 is a COTS offering and is packaged as a microbox PC with a passive PCI bus backplane. This configuration allows the component modularity for easy upgrades as computer hardware technologies improve. The microcontroller 150 is reside on a single board computer (SBC) that already have its peripheral interfaces built in: PCI bus, Ethernet, and RS-232 serial. Flash memory and DRAM can be sized to the control system requirements with removable memory sockets on the SBC. Communication from the microcontroller 150 to the sample introduction module 110, the agent concentration module 120, and the detection module is handled by COTS data acquisition, digital input/output, and analog input/output circuit cards that are PCI bus compatible. This approach is cost effective while meeting most commercial environmental requirements

The external port 160 is used for downloading software upgrades to the flash memory 140 and performing external trouble-shooting/diagnostics. In one embodiment, the detection system 100 is powered by a long-life battery or batteries that can be recharged and reused. Preferably, the batteries are interchangeable with batteries from other Northrop Grumman portable systems.

In one embodiment, field-programmable gate array (FPGA) technology is used for monitors and control circuits in order to keep the weight, size, and especially power consumption at a minimum. The FPGA technology also affords minimum hardware redesign impact when implementing system upgrade.

In another embodiment, all the modules and parts of the modules of the detection system 100 are easily replaceable. Preferably, the modules are small enough to fit into a handheld device. In one embodiment, ambient air is used for system purges so that no on-board gas containers or gas generators are needed.

The detection system 100 of the present invention, with its combined sample introduction, agent concentration, and agent detection capability, can also be used to concentrate, detect, and identify trace levels of CWA or TIC vapors by collecting these vapors on the sorbent material prior to generation of target agent vapors by the heater 114. In this case, the detection module 130 will interrogate the sorbent material just prior to generation of target agent vapors from the sample introduction module 110.

In one embodiment, the detection system 100 of the present invention is utilized to concentrate trace levels of chemical warfare agent breakdown products, precursors, volatile organic compounds (VOCs), and the actual chemical warfare agents onto commercial off-the shelf pre-concentration media commonly used to pre-concentrate chemical vapors prior to analysis.

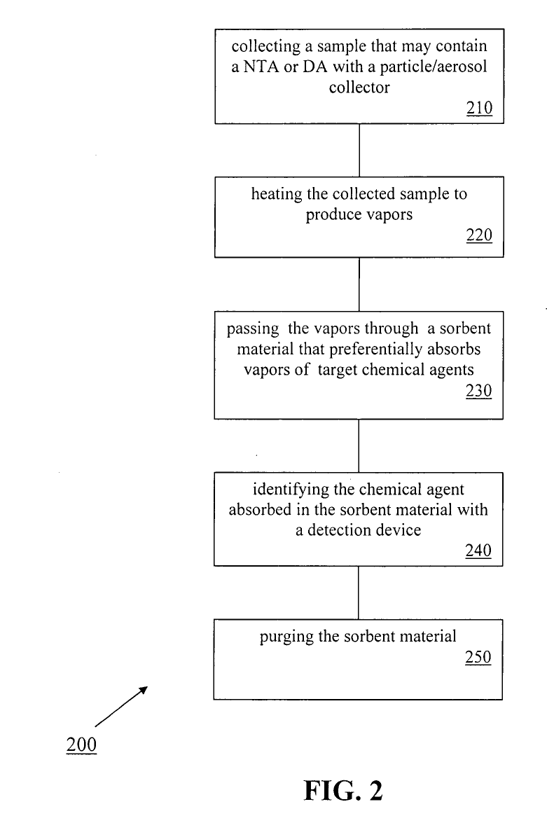

Another aspect of the present invention relates to a method for detecting a chemical agent. As shown in FIG. 2, the method 200 comprises the steps of collecting (210) a sample that may contain a chemical agent with a particle/vapor collector; heating (220) the collected sample to produce vapors, passing (230) the vapors through a sorbent material that preferentially absorbs vapors of target chemical agents; and identifying (240) a chemical agent absorbed in the sorbent material using s detection device.

In one embodiment, the CWA vapors absorbed in the sorbent material are identified using a spectroscopic technique. In another embodiment, the spectroscopic technique is Raman spectrometry or infrared spectrometry. In yet another embodiment, the CWA vapors absorbed in the sorbent material are identified using an Ahura hand held Raman FirstDefender system (Ahura Corporation, Wilmington, Mass.).

In another embodiment, the method 200 further comprises the step of purging (250) the sorbent material after the identification step.

In another embodiment, the method 200 further comprises the step of performing periodic back ground noise checks to characterize the dynamic range and sensitivity.

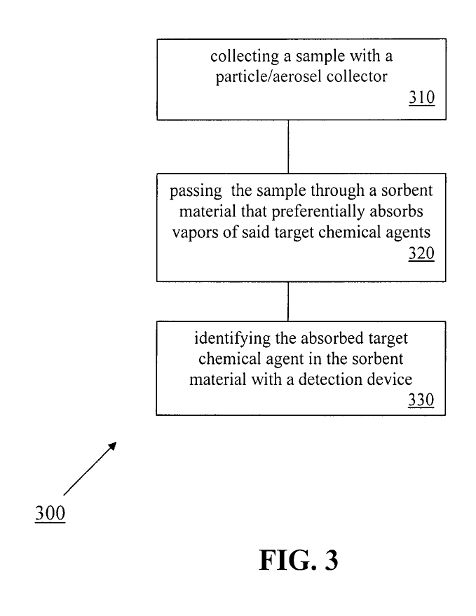

Yet another aspect of the present invention relates to a method for detecting trace levels of chemical warfare agent (CWA) or toxic industrial chemical (TIC) vapors. As shown in FIG. 3, the method comprises the steps of collecting (310) a sample with a particle/aerosol collector, passing (320) the sample through a sorbent material that preferentially absorbs vapors of CWA and TIC; and identifying (330) the absorbed vapors in the sorbent material using s detection device.

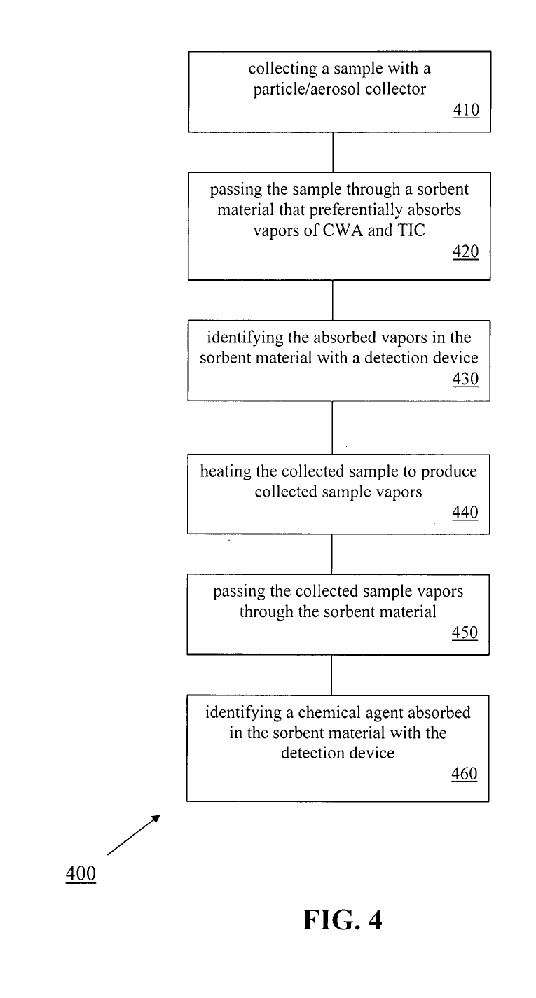

One skilled in the art would understand that method 200 and method 300 maybe combined in a single procedure 400. As shown in FIG. 4, the procedure comprises the steps of: collecting (410) a sample with a particle/aerosol collector, passing (420) the sample through a sorbent material that preferentially absorbs vapors of CWA and TIC; identifying (430) the absorbed vapors in the sorbent material using s detection device, heating (440) the collected sample to produce collected sample vapors, passing (450) the collected sample vapors through the sorbent material; and identifying (460) a chemical agent absorbed in the sorbent material using the detection device.

The embodiments illustrated and discussed in this specification are intended only to teach those skilled in the art the best way known to the inventors to make and use the invention. Nothing in this specification should be considered as limiting the scope of the present invention. The above-described embodiments of the invention may be modified or varied, and elements added or omitted, without departing from the invention, as appreciated by those skilled in the art in light of the above teachings. It is therefore to be understood that, within the scope of the claims and their equivalents, the invention may be practiced otherwise than as specifically described.

1. A chemical agent detection system, comprising:
a sample introduction module comprising
a sample collector that collects particles and aerosols from a sample; and
a heater positioned to vaporize the collected particles and aerosols and produces a sample vapor;
an agent concentration module comprising a sorbent tube filled with a sorbent material that preferentially absorbs the vapor of a target chemical agent when said sample vapor passes through said sorbent tube; and
a detection module that interrogates said sorbent material and identifies the target chemical agent absorbed to said sorbent material.

2. The chemical agent detection system of claim 1, wherein said detection module comprises a Raman spectrometer.

3. The chemical agent detection system of claim 2, wherein said Raman spectrometer is an Ahura hand held Raman FirstDefender system.

4. The chemical agent detection system of claim 1, wherein said detection module comprises an infrared spectrometer.

5. The chemical agent detection system of claim 1, wherein said sample collector is an electrostatic collector.

6. The chemical agent detection system of claim 1, wherein said sorbent material is selected from the group consisting of 2,6-diphenylene oxide, PIB (poly(isobutylene)), SXPH (75% phenyl-25% methylpolysiloxane), PEM (polyethylene maleate), SXCN (poly bis(cyanopropyl) siloxane), PVTD (poly (vinyltetradecanal)), PECH (poly(epichlorohydrin)), PVPR (poly(vinyl propionate)), OV202 (poly(trifluoropropyl) methyl siloxane), P4V (poly(4-vinylhexafluorocumyl alcohol)), SXFA (1-(4-hydroxy, 4-trifluoromethyl,5,5,5-trifluoro)pentene methylpolysiloxane), FPOL (fluoropolyol), PEI (poly(ethyleneimine), SXPYR (alkylaminopyridyl-substituted siloxane), and polysilsesquioxane.

7. The chemical agent detection system of claim 6, wherein said sorbent material is 2,6-diphenylene oxide.

8. The chemical agent detection system of claim 1, further comprising a microcontroller, a flash memory, and an external port.

9. The chemical agent detection system of claim 8, wherein said flash memory contains a library of spectroscopic finger prints of chemical agents.

10. The chemical agent detection system of claim 8, wherein said microcontroller utilizes FPGA technology.

11. A method for detecting a non-traditional agent (NTA) or a dusty agent (DA), comprising:
collecting a sample that may contain a NTA or DA with a particle/aerosol collector;
heating the collected sample to produce vapors;
passing the vapors through a sorbent material that preferentially absorbs vapors of target chemical agents; and
identifying the chemical agent absorbed in the sorbent material using a detection device.

12. The method of claim 11, wherein said detection device uses a spectroscopic technique.

13. The method of claim 12, wherein said spectroscopic technique is Raman spectrometry or infrared spectrometry.

14. The method of claim 12, wherein the chemical agent absorbed in the sorbent material is identified using an Ahura hand held Raman FirstDefender system.

15. The method of claim 11, further comprising the step of purging the sorbent material after the identification step.

16. The method of claim 11, further comprising the step of performing periodic back ground noise checks to characterize the dynamic range and sensitivity of the detection device.

17. The method of claim 11, wherein said sample is collected with an electrostatic particle collector.

18. The method of claim 11, wherein said collected sample is heated to a temperature range of about 100° C. to 300° C. to produce vapors.

19. A method for detecting trace levels of target chemical agents, comprising:
collecting a sample with a particle/aerosol collector;
passing the sample through a sorbent material that preferentially absorbs vapors of said target chemical agents; and
identifying the absorbed target chemical agent in the sorbent material with a detection device.

20. The method of claim 19, wherein said target chemical agents comprise chemical warfare agents (CWA) and toxic industrial chemical (TIC) vapors.
